(19) United States
(12) Patent Application Publication
(10) Pub. No.: US 2011/0099522 A1
(43) Pub. Date: Apr. 28, 2011

(54) Mobile device and method for supporting list search based on item grouping

(75) Inventors: Jung Hee Kim, Suwon-si (KR); Sung Cheol Kim, Goyang-si (KR); Jeon II Lee, Suwon-si (KR)

(73) Assignee: Samsung Electronics Co., Ltd., Suwon-si (KR)

(21) Appl. No.: 12/925,510

(22) Filed: Oct. 22, 2010

(30) Foreign Application Priority Data
Oct. 26, 2009 (KR) 10-2009-0101795

(51) Int. Cl. G06F 3/048

(52) U.S. Cl. 715/830

(57) ABSTRACT

A mobile device and method support an effective and quick search for a specific item in a list of many items through a simple, convenient and intuitive input process and interface. When one of the lists is selected, the mobile device detects the total number of items contained in the selected list. Then the mobile device performs a grouping of the items included in the selected list by dividing the detected total number of items by a predefined number of item groups and a predefined number of displayable items. Also, the mobile device outputs the item groups on a display unit.

### CROSS-REFERENCE TO RELATED APPLICATION(S) AND CLAIM OF PRIORITY

The present application is related to and claims the benefit of priority under 35 U.S.C. §119(a) to a Korean patent application filed in the Korean Intellectual Property Office on Oct. 26, 2009, and assigned Serial No. 10-2009-0101795, the entire disclosure of which is hereby incorporated by reference.

### TECHNICAL FIELD OF THE INVENTION

The present invention relates in general to a mobile device and, more particularly, to a mobile device and method for supporting an effective search of a list by grouping many items in the list.

### BACKGROUND OF THE INVENTION

A mobile device refers to a kind of electronic device based on mobility and portability. With remarkable growths in related technologies, a great variety of mobile devices capable of supporting various end-user functions are increasingly popularized these days. Such mobile devices may employ many input techniques. For instance, a mobile device has a traditional keypad based on a layout of physical keys and occupying a considerable part of an outward appearance. Recently, in order to obtain a much larger display space under a limited size of the mobile device, the keypad is gradually removed and replaced by a touch screen in which a touch panel is disposed on a display unit.

A mobile device may store various contents and data, e.g., many phonebook items, in a memory unit. Because the mobile device inherently has a smaller-sized display space to promote its portability, the number of items to be displayed at a time on a display screen is extremely limited. Therefore, a user who desires to find a specific item in a list of many items may usually experience too much inconvenience.

### SUMMARY OF THE INVENTION

To address the above-discussed deficiencies of the prior art, it is a primary object to provide a mobile device and method for supporting an effective and quick search for a specific item in a list of many items through a simple, convenient, and intuitive input process and interface.

According to one aspect of the present invention, provided is a method for supporting a list search in a mobile device, the method including detecting a total number of items contained in a selected list. A grouping of the items included in the selected list is performed by dividing the detected total number of items by a predefined number of item groups and a predefined number of displayable items. And the item groups are output on a display unit.

According to another aspect of the present invention, provided is a mobile device supporting a list search, the mobile device including a memory unit configured to store at least one list that includes items. A control unit detects a total number of the items contained in a selected list and performs a grouping of the items included in the selected list by dividing the detected total number of items by a predefined number of item groups and a predefined number of displayable items. And a display unit outputs the item groups.

According to yet another aspect of the present invention, a device is provided. The device includes a display unit configured to display a user interface. A memory unit stores information. The memory unit includes a data region for storing at least one list that includes items containing user data, and a program region for storing a set of instructions. A control unit executes the set of instructions. The set of instructions instruct the control unit to detect a total number of the items contained in a selected list, perform a grouping of the items by dividing the detected total number of the items by a predefined number of item groups and a predefined number of displayable items, and output the item groups to the display unit.

Other aspects, advantages, and salient features of the invention will become apparent to those skilled in the art from the following detailed description, which, taken in conjunction with the annexed drawings, discloses embodiments of the invention.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates a mobile device in accordance with an embodiment of the present invention;

FIG. 2 illustrates a process for supporting a list search based on an item grouping in a mobile device in accordance with an embodiment of the present invention;

FIG. 3 illustrates a user interface of a mobile device in accordance with an embodiment of the present invention;

FIG. 4 illustrates a user interface of a mobile device in accordance with a embodiment of the present invention; and

FIG. 5 illustrates a user interface of a mobile device in accordance with an embodiment of the present invention.

### DETAILED DESCRIPTION OF THE INVENTION

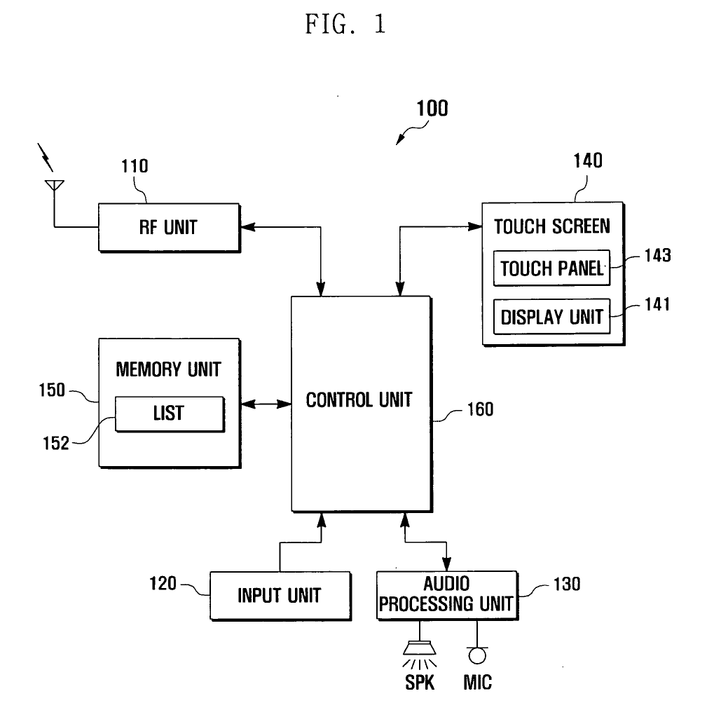

FIGS. 1 through 5, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged mobile device. This invention may, however, be embodied in many different forms and should not be construed as limited to the embodiments set forth herein. Rather, the disclosed embodiments are provided such that this disclosure will be thorough and complete, and will fully convey the scope of the invention to those skilled in the art. The principles and features of this invention may be employed in varied and numerous embodiments without departing from the scope of the invention.

Furthermore, known or widely used techniques, elements, structures, and processes may not be described or illustrated in detail to avoid obscuring the essence of the present invention. Although the drawings represent embodiments of the invention, the drawings are not necessarily to scale and certain features may be exaggerated or omitted in order to better illustrate and explain the present invention.

Among terms set forth herein, the number of displayable items refers to the maximum number of items that can be arranged on a display unit by a single touch and drag event. For instance, if a user touches a certain point on a touch screen and then drags in a certain direction, items outputted on the display unit are scrolled depending on the drag direction. At this time, the maximum number of items scrolled and displayed on the display unit when a touch and drag event occurs once is referred to as the number of displayable items. Meanwhile, the number of displayable items may be fixed with a default value or varied according to a user's setting.

FIG. 1 illustrates a mobile device in accordance with an embodiment of the present invention.

Referring to FIG. 1, the mobile device 100, according to an embodiment of this invention, includes a radio frequency (RF) unit 110, an input unit 120, an audio processing unit 130, a touch screen 140, a memory unit 150, and a control unit 160. Particularly, the touch screen 140 is composed of a display unit 141 and a touch panel 143. In addition, the memory unit 150 stores a list 152 of items.

The mobile device 100 with the above configuration enters into a list search mode in response to a user's request for a list search and also offers a user interface suitable for a list search. Particularly, the mobile device 100 performs a grouping of all items contained in the list 152, depending on the predefined number of item groups and the predefined number of displayable items. Additionally; when a user selects one of the item groups, the mobile device 100 determines whether items contained in the selected group is greater in number than the displayable items. If so, the mobile device 100 performs a secondary grouping of items in the selected group and then outputs them on the display unit 141. Such a repeated grouping and a selective displaying for all items in the list 152 may allow a quick and easy search for a specific item in the list 152.

Meanwhile, in order to assist a search for items assigned to a specific group, the mobile device 100 may offer a rainbow user interface (UI) that forms a partly or wholly curved band of different semitransparent colors. Namely, the rainbow UI has a striped pattern with several (e.g., seven) stripes. This striped pattern assumes a curved form of a touch area, thus increasing a dragging distance corresponding to the extent of a scroll made on a screen. Therefore, the mobile device 100 can increase the number of items that may be searched through a single touch and drag event. Additionally, when a user selects one of the colors in a rainbow touch map, the mobile device 100 supports a direct search for items assigned to a group indicated by the selected color.

Now, each individual element of the mobile device 100 will be described in detail.

The RF unit 110 establishes communication channels necessary for a voice call, a video call, data transmission, and such, under the control of the control unit 160. Namely, the RF unit 110 forms a voice call channel, a video call channel, a data communication channel, and such, with a mobile communication system. The RF unit 110 may include an RF transmitter that upwardly converts the frequency of signals to be transmitted and amplifies the signals, and an RF receiver that amplifies received signals with low-noise and downwardly converts the frequency of the received signals. The RF unit 110 may support various end-user functions based on a mobile communication service of the mobile device 100. For instance, depending on a communication channel formed with a mobile communication system, the RF unit 110 supports various end-user functions such as a voice call function, a video call function, an SMS (short message service) function, an MMS (multimedia message service) function, a web access function, a file download function, and such.

While the RF unit 110 supports the above functions, the mobile device 100 may save a call log in connection with the use of the RF unit 110. The call log is saved in the form of a list and may contain several tens or hundreds of call log items. Also, while supporting the file download function, the RF unit 110 may receive some files from a web server and deliver them to the memory unit 150 under the control of the control unit 160. Such files received through the RF unit 110 may be saved in the form of a list according to a specific format available for the mobile device 100.

The input unit 120 includes a plurality of input keys and function keys to receive a user's input and to set various functions. The function keys may have navigation keys, side keys, shortcut keys, and any other special keys defined to perform particular functions. The input unit 120 may be formed of a keypad that includes a plurality of physical keys arranged in a QWERTY, 3*4, or 4*3 key layout. Also, the input unit 120 may have a virtual key layout such as a QWERTY, 3*4, or 4*3 key map, a menu map and a soft key map displayed on the touch screen 140. Particularly, the input unit 120 may create an input signal for entering into a list search mode, an input signal for selecting one of the groups arranged on the display unit 141, and an input signal for selecting one of the items contained in the selected group, and deliver such input signals to the control unit 160. If the touch screen 140 has a full screen form, the input unit 120 may be composed of the touch screen 140 and side keys disposed on lateral sides of the mobile device 100.

The audio processing unit 130 includes a speaker (SPK) for outputting various audio data received during a call, contained in a received message, or produced by a playback of an audio file stored in the memory unit 150, and a microphone (MIC) for collecting a user's voice and any other audio signals during a call. Particularly, the audio processing unit 130 may output predefined sound effects when one of the groups is selected in the list search mode, predefined sound effects when a user touches the rainbow UI displayed on a layer of displayed items, and so forth.

The touch screen 140 includes the display unit 141 and the touch panel 143. In the touch screen 140, the touch panel 143 may be disposed on the front side of the display unit 141, completely covering the display unit 141. The size of the touch screen 140 may depend on that of the touch panel 143. For instance, the touch screen 140 may be provided in the form of a full screen that completely covers the display unit 141.

The display unit 141 represents a variety of information entered by a user or offered to a user, including various menus of the mobile device 100. For example, the display unit 140 may visually offer various screen views of an idle screen, a menu screen, a message writing screen, a call screen, and so forth. The display unit 140 may be formed of LCD (liquid crystal display), OLED (organic light emitting diodes), or any other equivalent. In addition, the display unit 141 may be disposed under the touch panel 143.

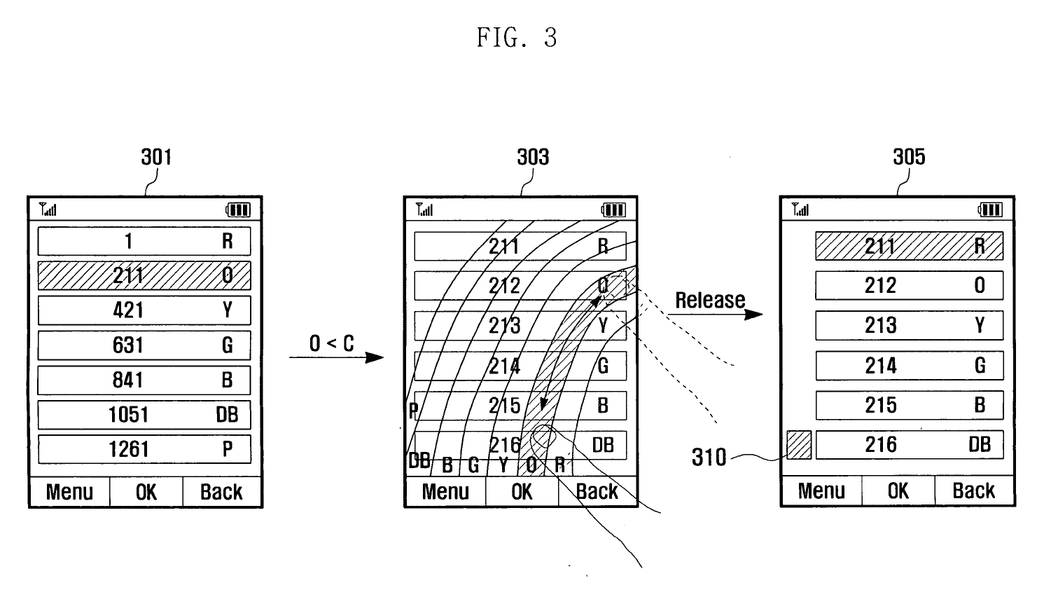

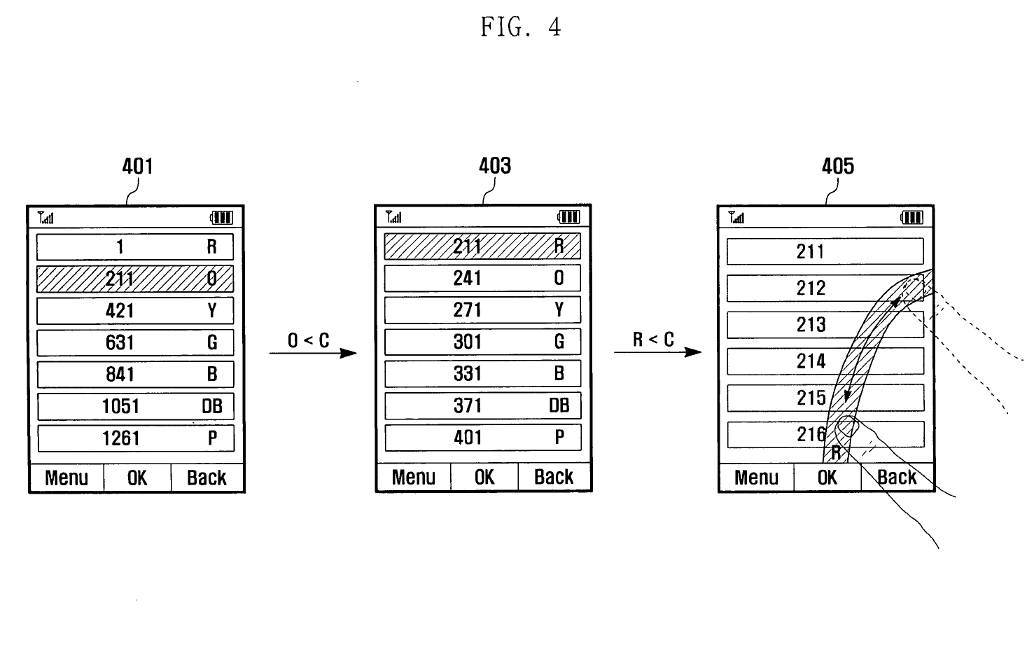

Particularly, the display unit 141 outputs a list search screen in the list search mode. The list search screen represents at least one item group into which all items in a selected list are classified. When one of the item groups is selected, the list search screen shifts a screen view and represents items assigned to the selected item group. At this time, the display unit 141 may output the rainbow UI with a scroll function to allow a search for undisplayed items among all items contained in the selected group. Additionally, the display unit 141 may have the first and second layers. The first layer outputs some of the items contained in the selected group. The second layer is located above the first layer (i.e., the first layer is overlaid with the second layer) and outputs a rainbow touch map for scrolling items displayed on the first layer. When the rainbow touch map is displayed, the mobile device 100 sets the touch panel 143 and thereby supports a scroll function of the rainbow touch map. Namely, using the rainbow touch map outputted on the display unit 141 and also setting the touch panel 143, the mobile device 100 may provide the rainbow UI. The rainbow UI will be described in detail with reference to FIGS. 3 and 4.

The touch panel 143 is placed on and attached to the'display unit 141. The touch panel 143 generates a touch event in response to a user's touch on a specific image or item displayed on the display unit 141. Particularly, the touch panel 143 may generate a touch event in response to a touch on respective item groups displayed on the display unit 141 in the list search screen. In addition, if the rainbow touch map is displayed on the second layer of the display unit 141, the touch panel 143 may generate a touch event in response to a touch on the rainbow touch map.

The memory unit 150 stores a variety of applications for functions related to an embodiment of this invention. In addition, the memory unit 150 may store a key map, a menu map, a soft key map, a rainbow touch map, and so forth, for the operation of the touch screen 140. Here, the key map may have various types such as a keyboard map, a 3*4 key map, a QWERTY key map, or a special control key map suitable for the operation of a specific application in use. Also, the menu map may be a special menu map suitable for the operation of a specific application in use and may have several menu items offered by the mobile device 100. The memory unit 150 may consist of a program region and a data region.

The program region may store an operating system (OS) for booting and operating the mobile device 100, and applications for performing various functions of the mobile device 100, such as a call application, a web browser for surfing on the Internet, an MP3 application for playing digital sounds, an image viewer application for showing image files, a video player application, a game application, and so forth. Particularly, the program region stores a list search mode supporting application and a rainbow UI application.

The list search mode supporting application may be loaded in the control unit 160 and support a list search when a relevant menu item is selected or a relevant hot key is activated. Specifically, the list search mode supporting application may contain a routine for detecting the total number of items in a selected list, a routine for detecting the number of item groups to be outputted on the display unit 141, a routine for dividing the total number of items by the predefined number of item groups, a routine for determining whether the number of items contained in the selected group is greater than a given number, a routine for dividing the number of items in the selected group by the predefined number of subordinate item groups if the number of items contained in the selected group is greater than a given number, and a routine for outputting selected items and then activating the rainbow UI application if the number of items contained in the selected group is not greater than a given number. The number of item groups may be a certain natural number such as 6, 7, 8, and so forth. The number of subordinate item groups may be equal to or different from that of item groups. These numbers may be fixed with a default value or varied according to a user's setting.

The rainbow UI application may be activated by the list search mode supporting application. The rainbow UI application may contain a routine for arranging some of the items contained in the selected group on the first layer of the display unit 141 when the number of items contained in the selected group is not greater than a given number, a routine for outputting the rainbow UI on the second layer of the display unit 141 in order to allow items arranged on the display unit 141 to be scrolled in response to a touch event or an input signal from the input unit 120, a routine for supporting a scroll function depending on any event occurring on the rainbow UI, a routine for removing or downscaling the rainbow UI or for shifting between the first and second layers in response to a relevant event occurring on the rainbow UI, and a routine for outputting detailed information about a selected item or for performing a particular function of the mobile device 100 in connection with the selected item. Among the above routines, the rainbow UI outputting routine applies semitransparent colors to the rainbow UI outputted on the second layer such that items on the first layer can be seen. Also, this routine sets the touch panel 143 depending on the rainbow touch map in order to allow a touch event to occur on the rainbow UI.

The data region stores data created while the mobile device 100 is used. For instance, the data region may store phonebook data, icons, contents, and user's inputs received from the touch screen 140. Particularly, the data region may store a variety of lists 152 supported by the mobile device 100 and many items contained in each individual list 152. For instance, the list 152 may include a phonebook list, a call log list, a file list, a content list, and such. The phonebook list may have user data such as a user name, a phone number, an address, a birthday, and such. The call log list may have incoming call items, outgoing call items, received message items, sent message items, missed call items, and all items. The file list may have music file items, video file items, and photo file items. The data region also stores the rainbow touch map that is invoked by the rainbow UI outputting routine.

The control unit 160 controls a power supplying and initializing process for each element of the mobile device 100. After initializing, the control unit 160 may control an offer of a UI for supporting the list search mode and also control the output of items in response to input signals.

Particularly, when receiving an input signal for entering into the list search mode at a user's request, the control unit 160 may activate the list search mode supporting application and then support performing processes defined in each routine. Specifically, the control unit 160 detects the total number of items contained in a specific list selected by a user through the input unit 120 or the touch screen 140, and then performs a grouping of items by dividing the detected total number by both the predefined number of item groups and the predefined number of displayable items. Additionally, the control unit 160 offers prearranged UIs corresponding to the item groups and then, when a user selects one of the item groups, determines whether the number of items contained in the selected group is greater than a given number.

If the number of items contained in the selected group is greater than a given number, the control unit 160 performs a secondary grouping by dividing the number of items in the selected group by both the predefined number of subordinate item groups and the predefined number of subordinate displayable items. Also, the control unit may output a suitable UI for selecting a specific item group.

Alternatively, if the number of items contained in the selected group is not greater than a given number, the control unit 160 outputs items contained in the selected group on the display unit 141 and also outputs the rainbow UI that allows a simple touch based search for all items contained in the selected group. At this time, the control unit 160 outputs at least some of the items in the selected group on the first layer and also constructs the rainbow UI that includes the rainbow touch map on the second layer that overlays the first layer. In addition, the control unit 160 keeps the rainbow touch map on the second layer in a semitransparent state in order to allow a search for items arranged on the first layer. Also, if receiving a touch and drag event occurring on the rainbow UI, the control unit 160 may scroll the items on the first layer depending on the drag direction.

Meanwhile, if a touch-up or release event occurs on the second layer, the control unit 160 may remove the rainbow UI on the second layer from the display unit 141 or shift between the first and second layers such that a user can directly select or manipulate items on the first layer. At this time, the control unit 160 may change the rainbow UI displayed on the second layer into a downscaled image or icon on the first layer and then, if a user selects the downscaled image or icon, may output it again on the second layer.

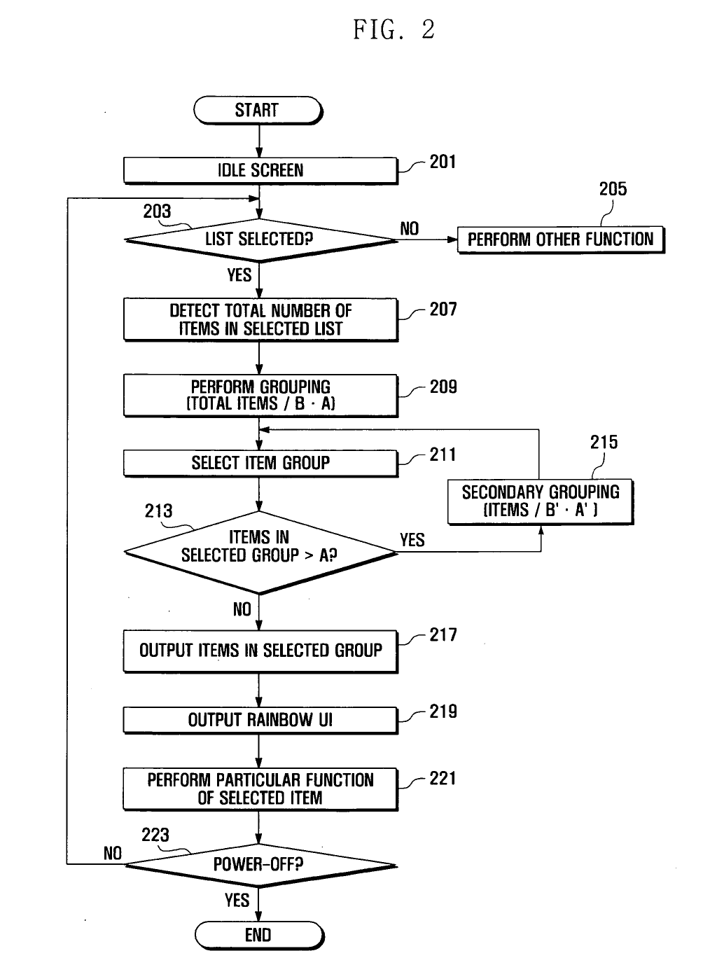

Now, a method for supporting a list search will be described in detail with reference to FIG. 2.

FIG. 2 illustrates a process for supporting a list search based on an item grouping in a mobile device in accordance with an embodiment of the present invention.

Referring to FIGS. 1 and 2, when power is supplied, the control unit 160 of the mobile device 100 performs a booting process and initializes the respective elements. In block 201, the control unit 160 outputs a predefined idle screen on the display unit 141.

Meanwhile, in the idle state, the input unit 120 and the touch screen 140 may create an input signal by a user's manipulation. For instance, the input unit 120 may create a key input signal, and the touch screen 140 may create an input signal corresponding to a touch event occurring thereon. In block 203, the control unit 160 determines whether an input signal received from the input unit 120 or the touch screen 140 is for entering into a list search mode.

If the received input signal is not for entering into the list search mode, the control unit 160 performs a particular function corresponding to the received input signal in block 205. For instance, the control unit 160 may perform a selected end-user function such as a call function, a file search function, a file play function, a camera function, and such, in response to the received input signal.

If the received input signal is for entering into the list search mode, namely if one of the lists 152 is selected, the control unit 160 detects the total number of items contained in the selected list in block 207. In block 209, the control unit 160 performs a grouping of items in the selected list (i.e., determines some numbers of item groups to be displayed on the display unit 141) and then outputs a prearranged UI on the display unit 141. Specifically, in block 209, the control unit 160 divides the total number of items by both the predefined number (B) of item groups and the predefined number (A) of displayable items. Here, these predefined numbers (A) and (B) may be a certain natural number. For example, the number (B) of item groups may be seven, and the number (A) of displayable items may be thirty. Related descriptions will be given with reference to FIGS. 3 and 4.

In block 211, the control unit 160 recognizes a user's selection of a specific item group by receiving a relevant input signal from the input unit 120 or the touch screen 140. Here, a user can touch a specific region on the touch screen 140 or press a specific key of the input unit 120 so as to select a desired item group.

In block 213, the control unit 160 determines whether the number of items contained in the selected group is greater than the number (A) of displayable items. If the number of items contained in the selected group is greater than the number (A) of displayable items, the control unit 160 performs a secondary grouping in block 215. Namely, in block 215, the control unit 160 divides the number of items in the selected group by both the predefined number (B′) of subordinate item groups and the predefined number (A′) of subordinate displayable items. After the secondary grouping, the control unit 160 returns to block 211. Here, the number (B′) of subordinate item groups may be equal to or different from that (B) of item groups. Similarly, the number (A′) of subordinate displayable items may be equal to or different from that (A) of displayable items.

If the number of items contained in the selected group is not greater than the number (A) of displayable items, the control unit 160, in block 217, outputs items contained in the selected group on the display unit 141. In block 219, the control unit 160 outputs the rainbow UI on an overlay layer above the items arranged on the display unit 141 so as to allow scrolling of the items. In block 221, if one of the items on the display unit 141 is selected, the control unit 160 performs a particular function in connection with the selected item.

In block 223, the control unit 160 determines whether there is an input signal to turn off the power. If there is no input signal for power-off, the control unit 160 returns to block 203 and then repeats the aforesaid process.

As discussed, the mobile device and method for supporting the list search according to an embodiment of this invention may allow an effective and quick search for a specific item in a list of many items through a simple, convenient and intuitive input process. Now, the user interface will be described in detail with reference to FIGS. 3 and 4.

FIG. 3 illustrates a user interface of a mobile device in accordance with an embodiment of the present invention.

Referring to FIGS. 1 and 3, as shown in the first screen view 301, the control unit 160 of the mobile device 100 may output predefined numbers of item groups in a selected list 152 on the display unit 141 in response to a relevant input signal received from the input unit 120 or the touch screen 140. It is supposed that the above input signal is to search a phonebook list that contains two hundred ten items corresponding to user data. Therefore, the control unit 160 finds that the total number of all items contained in the phonebook list stored in the memory unit 150 is two hundred ten (‘210’). Then the control unit 160 performs a grouping of such items in the phonebook list. Specifically, the control unit 160 divides the total number (‘210’) of items by both the predefined number of item groups and the predefined number of displayable items and then, based on divided results, assigns items to the item groups in order. Here, it is supposed that the number of item groups is seven and the number of displayable items is thirty. Also, it is supposed that, by grouping, all items in the phonebook list are arranged in order and indicated by numerals 1˜30, 211˜240, 421˜450, 631˜660, 841˜870, 1051˜1080, and 1261˜1290. Alternatively, all items and their groups may be indicated by letters such as alphabet or any other equivalent.

When using the alphabet, the control unit 160 may assign letters “a, b, c, d, e, f, g, . . . ” to the item groups, respectively, and output them on the display unit 141. Alternatively, the control unit 160 may assign another set of letters “a, d, g, . . . ” to the item groups. The letters assigned to the item groups may be determined in consideration of the total number of items. Specifically, let's suppose that letters from a to z are used for two hundred ten items and also the number of displayable items is thirty. If a certain item has a letter “a” as an index at the first or any other predetermined place of its user data, the control unit 160 may assign this item to the first item group. If in the first item group such items that include a letter “a” as an index at a given place do not exceed thirty (i.e., the number of displayable items), the control unit 160 may further assign items that include a letter “b” as an index to the first item group. Similarly, if items with “a” or “b” in the first item group are less than thirty, the control unit 160 may further assign items with “c” to the first item group. If any item with “c” fails to fall within the first item group that is already full of previous items, the control unit 160 may assign items with “c” to the second item group. In such a way, the control unit 160 may assign all items to the respective item groups. After assigning items to the sixth item group, all the remaining items may be assigned to the seventh item group even though exceeding thirty. This will be described later.

As shown in the first screen view 301, the display unit 141 may display seven item groups in regular order under the control of the control unit 160. At this time, certain grouping information (e.g., 1, 211, 421, and such) and indices (e.g., R, O, Y, and such) may be represented together with each item group. The above index is used for indicating a mapping with the rainbow UI. Namely, indices R, O, Y, G, B, DB, and P stand for red, orange, yellow, green, blue, dark blue, and purple, respectively. Such indices may be omitted or varied according to a user's setting or default.

Meanwhile, if a user selects the second item group in the first screen view 301, the control unit 160 determines whether the number of items contained in the selected group is greater than the number of displayable items. If the number of items in the selected group is not greater than that of displayable items, the control unit 160 may arrange some items (e.g., 211, 212, 213, and so forth) in the selected group on the first layer of the display unit 141 in regular order as shown in the second screen view 303. At this time, the control unit 160 may arrange items from the first item, from any intermediate item, or from the last item in the selected group according to a user's setting or default.

Additionally, the control unit 160 may output, on the second layer, the rainbow UI supporting a scroll function to allow a search for items displayed on the first layer. At this time, the control unit 160 may give a highlight to the orange stripe corresponding to the selected second group on the display unit 141. Thereafter, if a user touches and drags the orange stripe in the rainbow UI on the touch panel 143, the control unit 160 may scroll items arranged on the first layer in response to a touch and drag event. Preferably, the rainbow UI on the first layer may have semitransparent colors such that items on the first layer can be seen.

Meanwhile, if a touch-up or release event occurs on the second layer of the display unit 141 while the items are scrolled on the first layer, the control unit 160 may remove the second layer with the rainbow UI from the display unit 141 as shown in the third screen view 305. At this time, the control unit 160 may change the rainbow UI into a downscaled image or icon 310 and then dispose it on the first layer of the display unit 141. Alternatively, the control unit 160 may shift between the first and second layers. Therefore, the second layer outputting the rainbow UI is placed under the first layer outputting items. This process of removing or changing the rainbow UI is not always performed depending on a touch-up event based on the touch screen 140. The control unit 160 may perform this process in response to any other given input signal received from the input unit 120 or the touch screen 140.

A user can select another colored stripe on the rainbow UI shown in the second screen view 303. If a user selects a purple stripe for example, the control unit 160 may remove current items from the first layer of the display unit 141 and then output items contained in a group corresponding to the purple stripe. At this time, the control unit 160 may output indices (e.g., R, O, Y, and so forth) in the respective stripes. This index indicates a group corresponding to a stripe and may be replaced by any other equivalent.

Each stripe of the rainbow UI has a partly or wholly curved form on the display unit 141. This curved stripe can give a longer touch area to a user than a straight stripe. Namely, because the length of a drag event for scrolling items is increased, a user can search much more items through a single touch and drag. The shape of stripes in the rainbow UI is shown in the drawings only for illustrative purposes. Any other various shapes may be applied to such stripes of the rainbow UI.

As will be discussed, the user interface for supporting the list search mode, including the rainbow UI, may allow a user to easily select a group that includes a desired item in a list of many items, and also to quickly search items contained in the selected group through a simple touch manipulation.

FIG. 4 illustrates a user interface of a mobile device in accordance with an embodiment of the present invention.

Referring to FIGS. 1 and 4, as shown in the first screen view 401, the control unit 160 of the mobile device 100 may output predefined numbers of item groups in a selected list 152 on the display unit 141 in response to a relevant input signal received from the input unit 120 or the touch screen 140. If receiving an input signal for searching a phonebook list that contains one thousand four hundred seventy (‘1470’) items corresponding to user data, the control unit 160 finds that the total number of all items in the phonebook list is one thousand four hundred seventy (‘1470’). Then the control unit 160 performs a grouping of such items in the phonebook list. Specifically, the control unit 160 divides the total number (‘1470’) of items by both the predefined number of item groups and the predefined number of displayable items and then, based on divided results, assigns items to the item groups in some sequential order. For example, suppose that the number of item groups is seven (‘7’) and the number of displayable items is thirty (‘30’). And let's further suppose that, by grouping, all items in the phonebook list are arranged in order and indicated by numerals 1˜210, 211˜420, 421˜630, 631˜840, 841˜1050, 1051˜1260, and 1261˜1470. Alternatively, all items and their groups may be indicated by letters such as the alphabet or any other equivalent.

After grouping of all items, the control unit 160 may output seven item groups on the display unit 141, together with their grouping information (e.g., 1, 211, 421, and so forth) to identify each group. This grouping information may use the start numeral or the last numeral in each group. In addition, the display unit 141 may further display some indices (e.g., R, O, Y, and such) in respective groups to support the rainbow UI.

If a user selects the second item group in the first screen view 401, the control unit 160 finds the number of items contained in the selected second group. Here, the number of items in the second group is two hundred ten (‘210’) from 211 to 420. If the number of items in the selected group is greater than that of displayable items, the control unit 160 performs a secondary grouping of such items in the selected group. Specifically, the control unit 160 divides the number (‘210’) of items in the selected group by both the predefined number of subordinate item groups and the predefined number of subordinate displayable items and then, based on divided results, assigns items in the selected group to the subordinate item groups in order. If the number of subordinate item groups is seven (‘7’) and the number of subordinate displayable items is thirty (‘30’), the items in the second group may be further classified by thirty as shown in the second screen view 403. Therefore, the display unit 141 outputs seven (‘7’) subordinate item groups thereon under the control of the control unit 160. These subordinate item groups in the second group are indicated by numerals 211˜240, 241˜270, 271˜300, 301˜330, 331˜360, 361˜390, and 391˜420. At this time, the control unit 160 may further output secondary grouping information (e.g., 211, 241, 271, and so forth) to identify each subordinate group and also output some indices (e.g., R, O, Y, and so forth) in respective subordinate groups to support the rainbow UI.

If a user selects the first subordinate item group in the second screen view 403, the control unit 160 finds the number of items contained in the selected subordinate group. Then the control unit 160 determines whether the number of items in the selected subordinate group is greater than the number of subordinate displayable items. If the number of items in the selected subordinate group is not greater than that of subordinate displayable items, the control unit 160 may arrange some items (e.g., 211, 212, 213, and so forth) in the selected subordinate group on the first layer of the display unit 141 in regular order as shown in the third screen view 405.

Additionally, the control unit 160 may output, on the second layer, the rainbow UI that has only a single stripe corresponding to the selected subordinate group. Then the display unit 141 represents items in the selected first subordinate group on the first layer, and also represents the rainbow UI with a single stripe indicating the selected subordinate group on the second layer. Therefore, a user can scroll items on the first layer by conducting a touch and drag event on the touch panel 143.

Meanwhile, the number of items that can be outputted on the first layer may be varied according to the size and resolution of the display unit 141 or according to a user's setting. Namely, although the third screen view 405 shows six items displayed, this is for illustrative purposes only. Alternatively, more or less items may be displayed on a single screen of the display unit 141. In addition, the numbers of displayable items and subordinate displayable items may be varied according to a user's setting, and such. These numbers may be determined such that all items contained in the selected group or subordinate group can be searched through a single drag. Also, these numbers may be determined in consideration of resolutions of the touch panel 143 and the display unit 141. The number of subordinate displayable items may be equal to or different from that of displayable items. For instance, if the number of displayable items is thirty, the number of subordinate displayable items may be thirty, twenty, forty, and so forth.

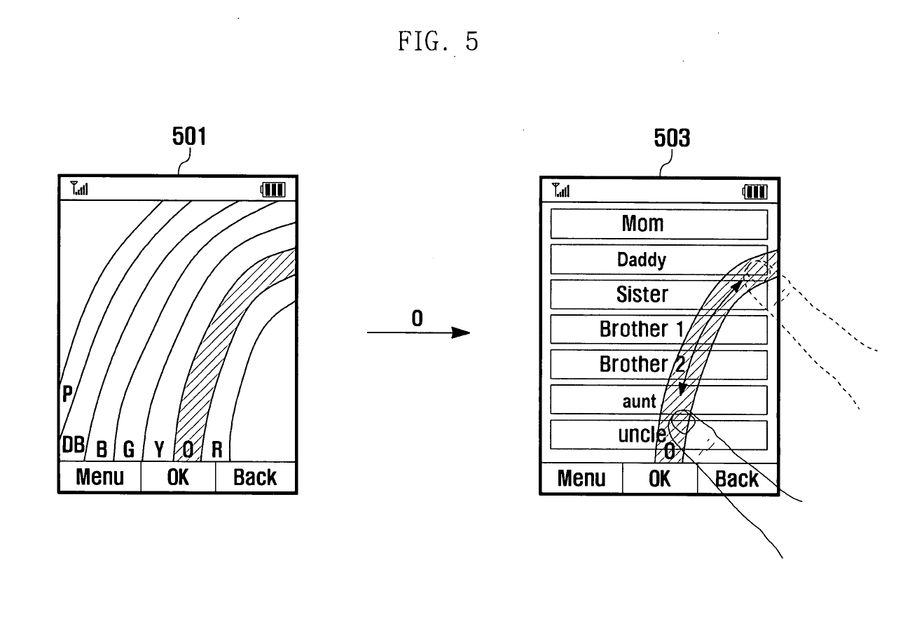

FIG. 5 illustrates a user interface of a mobile device in accordance with an embodiment of the present invention.

Referring to FIGS. 1 and 5, when receiving an input signal for a search of a phonebook list stored in the memory unit 150 from the input unit 120 or the touch screen 140, the control unit 160 may output the rainbow UI with curved stripes extending from a lower left to an upper right on the display unit 141 as shown in the first screen view 501. Additionally, the control unit 160 may output certain indices each of which indicates a specific color of each stripe on the display unit 141. Also, the control unit 160 may output certain grouping information that indicates a specific group or range of items to be searched when each stripe is selected.

If receiving an input signal for selecting the second group “O” from the input unit 120 or the touch screen 140 in the first screen view 501, the control unit 160 may output items contained in the selected second group on the display unit 141 as shown in the second screen view 503. Here, grouping information assigned to each stripe may by contact category. For instance, the control unit 160 may assign company colleague to the stripe “R” of the first group, assign family to the stripe “O” of the second group, assign friends to the stripe “Y” of the third group, and assign any other contact category to each of the other stripes. Also, in the first screen view 501, the control unit 160 may replace “R”, “O”, “Y”, and so forth, by other indices indicating “company”, “family”, “friends”, and so forth, respectively.

If the second group is selected depending on a relevant input signal from the input unit 120 or the touch screen 140, the control unit 160 may output some items related to “family” on the first layer. Additionally, the control unit 160 may output rainbow-like stripes on the second layer overlaying the first layer in order to support a search for other items not currently displayed on the display unit 141 among all items to be displayed on the first layer. Because each stripe has a curved form on the display unit 141, it can give a longer touch area to a user than a straight stripe. Therefore, a user can search much more items through a single touch and drag. Namely, such a rainbow-like stripe may correspond to a curved scroll bar.

Although the second screen view 503 shows a single stripe corresponding to a specific group selected in the first screen view 501, the other stripes may also be outputted on the second layer of the display unit 141. Furthermore, in the second screen view 503, the control unit 160 may output the rainbow UI on the second layer in a semitransparent state in order to allow a search for items arranged on the first layer. Also, if a touch-up event occurs on the second layer, the control unit 160 may remove the second layer with the rainbow UI from the display unit 141 or shift between the first and second layers. And also, responding to a touch-up event, the control unit 160 may change the rainbow UI displayed on the second layer into a downscaled image or icon on the first layer.

As fully discussed hereinbefore, the mobile device and method for supporting the list search according to an embodiment of this invention may allow a quick and easy search for many items through a simple, convenient, and intuitive touch-based input process.

Although in the aforesaid embodiments the display unit 141 arranges the items in an array formed of several rows and one column, this is for illustrative purposes only and not to be considered as a limitation of the present invention. Alternatively, any other arrays formed of one row and several columns or of several rows and columns may be applied to this invention.

The above-discussed mobile device 100 may essentially or selectively include any other elements. For instance, the mobile device 100 may further include a short distance communication module, a digital camera module, a wired or wireless data transmission interface, an Internet access module, a digital broadcast receiving module, and so forth. According to a digital convergence tendency today, such elements may be varied, modified and improved in various ways, and any other elements equivalent to the above elements may be additionally or alternatively equipped in the mobile device 100. In some embodiments, some of the above-mentioned elements in the mobile device 100 may be omitted or replaced with another.

Additionally, the mobile device 100 of this invention may include any types of electronic devices that may support a list scroll function. For example, the mobile device may include communication devices, multimedia players and their application equipment, especially including many mobile communication terminals based on various communication protocols, a portable multimedia player (PMP), a digital broadcasting player, a personal digital assistant (PDA), a music player (e.g., an MP3 player), a portable game console, a smart phone, a notebook, a handheld personal computer, and so forth.

Although the present disclosure has been described with an exemplary embodiment, various changes and modifications may be suggested to one skilled in the art. It is intended that the present disclosure encompass such changes and modifications as fall within the scope of the appended claims.

What is claimed is:

1. A method for supporting a list search in a mobile device, the method comprising:
detecting a total number of items contained in a selected list;
performing a grouping of items included in the selected list by dividing the detected total number of items by a predefined number of item groups and a predefined number of displayable items; and
outputting the item groups to a display unit.

2. The method of claim 1, wherein outputting the item groups includes outputting at least one of information about the items contained in each item group, index information about each item group, and grouping information about each item group.

3. The method of claim 1, further comprising:
selecting one of the item groups;
outputting the items contained in the selected item group on a first layer of the display unit; and
outputting a particular user interface on a second layer overlaying the first layer of the display unit in order to allow a scroll of the items on the first layer.

4. The method of claim 3, wherein outputting the particular user interface includes at least one of:
outputting at least one stripe region with one of a partly and wholly curved form;
outputting at least one stripe region with a predefined color;
outputting at least one stripe region with a predefined index;
outputting a predefined stripe region depending on the selected item group; and
outputting at least one stripe region in a semitransparent state.

5. The method of claim 4, further comprising:
receiving a touch and drag event from at least one stripe region on the second layer; and
scrolling the items on the first layer in response to the touch and drag event.

6. The method of claim 5, further comprising at least one of:
switching between the first and second layers if the touch and drag event is canceled;
removing the particular user interface from the second layer and then outputting the particular user interface in the form of one of a downscaled image and an icon on the first layer if the touch and drag event is canceled; and
removing the second layer with the particular user interface if the touch and drag event is canceled.

7. The method of claim 6, further comprising:
outputting again the particular user interface on the second layer when receiving one of a given input signal and an input signal for activating one of the downscaled image and icon.

8. The method of claim 1, further comprising:
selecting one of the item groups;
determining whether a number of items contained in the selected item group is greater than the number of the displayable items;
if the number of items in the selected item group is greater than the number of the displayable items, performing a secondary grouping of the items in the selected item group by dividing the number of the items in the selected item group by a predefined number of subordinate item groups and a predefined number of subordinate displayable items; and
outputting the subordinate item groups on the display unit.

9. A mobile device supporting a list search, the mobile device comprising:
a memory unit configured to store at least one list that includes items;
a control unit configured to detect a total number of items contained in a selected list, and perform a grouping of the items included in the selected list by dividing the detected total number of items by a predefined number of item groups and a predefined number of displayable items; and
a display unit configured to output the item groups.

10. The mobile device of claim 9, wherein the display unit is further configured to output at least one of information about the items contained in each item group, index information about each item group, and grouping information about each item group.

11. The mobile device of claim 9, wherein the display unit is further configured to output a first layer for outputting the items contained in a selected one of the item group, and output a second layer overlaying the first layer and including a touch map for a touch and drag event, the touch and drag event comprising at least one of a touch gesture and a drag gesture.

12. The mobile device of claim 11, wherein the second layer includes a particular user interface comprising at least one of:
at least one stripe region with one of a partly and wholly curved form;
at least one stripe region with a predefined color;
at least one stripe region with a predefined index;
a predefined stripe region depending on the selected item group; and
at least one stripe region outputted in a semitransparent state.

13. The mobile device of claim 12, further comprising:
a touch panel configured to generate the touch and drag event on at least one stripe region such that the control unit may scroll the items on the first layer in response to the touch and drag event.

14. The mobile device of claim 13, wherein the control unit is further configured, when the touch and drag event is canceled, to perform at least one of switching between the first and second layers, removing the particular user interface from the second layer and then outputting the particular user interface in the form of one of a downscaled image and an icon on the first layer, and removing the second layer with the particular user interface.

15. The mobile device of claim 14, wherein the display unit is further configured to output again the particular user interface on the second layer when the control unit receives one of a given input signal and an input signal for activating one of the downscaled image and the icon.

16. The mobile device of claim 9, wherein the control unit is further configured to, when one of the item groups is selected, determine whether a number of items contained in the selected item group is greater than the number of the displayable items, perform a secondary grouping of the items in the selected item group by dividing the number of the items in the selected item group by a predefined number of subordinate item groups and a predefined number of subordinate displayable items if the number of items in the selected item group is greater than the number of the displayable items, and output the subordinate item groups on the display unit.

17. A device comprising:
a display unit configured to display a user interface;
a memory unit configured to store information, the memory unit comprising a data region for storing at least one list comprising items containing user data, and a program region for storing a set of instructions; and
a control unit configured to execute the set of instructions, the set of instructions instructing the control unit to detect a total number of the items contained in a selected list, perform a grouping of the items by dividing the detected total number of the items by a predefined number of item groups and a predefined number of displayable items, and output the item groups to the display unit.

18. The device of claim 17, wherein the set of instructions further instruct the control unit to output at least one of information about the items contained in each item group, index information about each item group, and grouping information about each item group to the display unit.

19. The device of claim 17, wherein the set of instructions further instruct the control unit to output to the display unit a first layer for displaying the items contained in a selected item group, and to output a second layer overlaying the first layer and including a touch map for a touch and drag event that allows scrolling of the items on the display unit.

20. The device of claim 17, wherein, when one of the item groups is selected, the set of instructions further instruct the control unit to determine whether a number of items contained in the selected item group is greater than the number of the displayable items, perform a secondary grouping of the items in the selected item group by dividing the number of the items in the selected item group by a predefined number of subordinate item groups and a predefined number of subordinate displayable items if the number of items in the selected item group is greater than the number of the displayable items, and output the subordinate item groups on the display unit.
